(19) United States
(12) Patent Application Publication
(10) Pub. No.: US 2021/0091610 A1
(43) Pub. Date: Mar. 25, 2021

(54) STATOR TOOTH ARRANGEMENT

(71) Applicant: Stefan Walter, Nürnberg (DE)

(72) Inventor: Stefan Walter, Nürnberg (DE)

(21) Appl. No.: 17/029,274

(22) Filed: Sep. 23, 2020

(30) Foreign Application Priority Data
Sep. 24, 2019 (DE) 102019214518.3

(51) Int. Cl. H02K 1/14

(52) U.S. Cl. CPC H02K 1/148

(57) ABSTRACT

The disclosure relates to a stator tooth arrangement for a stator of an electric machine. The stator tooth arrangement includes a multiplicity of individual teeth, wherein the teeth are arranged in series when viewed in a tangential direction. Individual teeth of the stator tooth arrangement arranged adjacent to one another are connected positively to one another at their tooth roots by a connecting device of the stator tooth arrangement, with the result that, even under considerable radial loading, (e.g., shrink-fitting in the context of the production process of the machine), the stator tooth arrangement retains its very largely round shape.

The present patent document claims the benefit of German Patent Application No. 10 2019 214 518.3, filed Sep. 24, 2019, which is hereby incorporated by reference.

### TECHNICAL FIELD

The disclosure relates to an electric machine which may be used as an electric motor or as a generator, (e.g., for a drive system). In particular, the disclosure is directed to a stator of an electric machine of this kind and, more specifically, to the stator teeth provided in war on the stator.

### BACKGROUND

During the assembly of an electric machine, the stator ring may be shrunk into the stator housing. Specifically, in the case of electric machines in which the rotor is designed as an internal rotor and the stator is assembled from a multiplicity of individual teeth, there is the problem during the shrink fitting that deformation of the stator ring may occur during the shrink fitting of the stator into the machine housing. This deformation is due to the tolerance chain of the large number of individual stator teeth arranged adjacent to one another.

As a consequence, the pole shoes of the stator ring, which may be deformed elliptically during this process, have to be ground to provide that the radially inner side of the stator ring adopts the envisaged round shape, thus enabling the rotor to be positioned within the stator and, e.g., with a uniform air gap. The deviation in manufacture from the optimal electromagnetic configuration of the stator resulting, however, from the grinding leads to unwanted losses of efficiency in the electric machine.

In principle, one solution to the problem is to weld together the individual teeth, e.g. at the backs or tooth roots thereof, in order in this way to prevent deformation of the stator during shrink fitting. However, this has the disadvantage that the weld seams may split, possibly due to high mechanical stresses, and thus, ultimately, deformation is not prevented.

### SUMMARY AND DESCRIPTION

It is therefore an object of the present disclosure to specify a possible way of enabling an electric machine to be produced without the stated problems.

This object is achieved with the aid of the stator tooth arrangement, the stator, and the electric machine disclosed herein. The scope of the present disclosure is defined solely by the appended claims and is not affected to any degree by the statements within this summary. The present embodiments may obviate one or more of the drawbacks or limitations in the related art.

A stator tooth arrangement for a stator of an electric machine includes a multiplicity of individual teeth. Each tooth of the multiplicity of individual teeth has a tooth head facing a rotor of the machine, a tooth root facing away from the rotor, and a tooth neck arranged between the tooth head and the tooth root. The individual teeth are arranged in series when viewed in a tangential direction. Here, individual teeth of the stator tooth arrangement arranged adjacent to one another are connected positively to one another at their tooth roots by a connecting device of the stator tooth arrangement. This positive connection is advantageous in that the effects mentioned at the outset do not occur during shrink fitting.

The connecting device includes a multiplicity of mutually complementary devices, wherein each individual tooth has one of the complementary devices on each side of the two tangential sides of its tooth root. The individual teeth are provided with the devices and arranged in series when viewed in the tangential direction in such a way that devices on mutually facing tangential sides of two adjacent individual teeth are complementary to one another and bring about a positive connection of the respectively adjacent individual teeth when they are positioned one inside the other.

In this context, “mutually complementary devices” is intended to mean that each device from a first partial quantity of the devices is complementary to a device from a second partial quantity of the devices. Furthermore, the term “positioned one inside the other” expresses the fact that one device may be positioned within the device complementary thereto. Owing to the complementarity of the devices, the devices positioned one inside the other may be in contact without gaps or over their full area by their respective inner and outer surfaces.

Some or a partial quantity of the devices are/is implemented in the form of groove-type depressions, and other devices or a second partial quantity of the devices are/is implemented in the form of projections complementary to the depressions. The depressions and projections may be configured in such a way that they fit positively with one another.

Thus, the connecting device may be designed in such a way, for example, for the positive connection of two adjacent individual teeth forming a pair from the multiplicity of individual teeth, that, on a first of the two individual teeth of the pair, a groove-type depression is provided that is arranged on a first tangential side, facing the other individual tooth of the pair, of the tooth root of this first individual tooth. Further, on the second of the two individual teeth of the pair, a projection is provided that is complementary to the depression and is arranged on a tangential side, facing the first individual tooth of the pair, of the tooth root of the second individual tooth.

In a symmetrical embodiment of an individual tooth, the devices on both sides of the tooth root of each individual tooth are of the same type, e.g., either there are on each individual tooth groove-type depressions on both tangential sides of the tooth root, or the projections complementary to the groove-type depressions are provided on both tangential sides of the tooth root. Accordingly, the individual teeth formed in this way are symmetrical in the axial direction of view.

In an asymmetrical embodiment of an individual tooth, the devices arranged on both sides of the tooth root of each individual tooth are complementary to one another, e.g., there is a groove-type depression on one tangential side and the projection complementary thereto on the other side. Accordingly, the individual teeth formed in this way are asymmetrical in the axial direction of view.

In one embodiment, for at least two adjacent individual teeth, (e.g., all the individual teeth), the devices arranged on the mutually facing tangential sides of these adjacent individual teeth may be designed in such a way that the teeth form a dovetail joint with one another. Ultimately, this means that, when viewed in the axial direction, the cross sections of depressions and of projections complementary thereto are trapezoidal, wherein the short side of the trapezium is at the tooth root and the long side is away from the tooth root.

In another embodiment, for at least two adjacent individual teeth, (e.g., for all the individual teeth), the devices arranged on the mutually facing tangential sides of these adjacent individual teeth may be designed in such a way that the teeth form a round head joint with one another. Ultimately, this means that, when viewed in the axial direction, the cross sections of depressions and of projections complementary thereto are round or circular, or oval or elliptical.

Both in the embodiment as a dovetail joint and in the embodiment with a round head joint, the devices on the respective tangential sides of the respective tooth root may extend in an axial direction.

In another embodiment, for at least two adjacent individual teeth, (e.g., for all the individual teeth), the devices arranged on the mutually facing tangential sides of these adjacent individual teeth may be designed in such a way that a retaining the connecting devices may be placed there in such a way that it supports the positive connection of these adjacent individual teeth or, in extreme cases, exclusively establishes the connection, (e.g., if, unlike in the case of the dovetail or round head connection, positive engagement is not achieved exclusively based on the shaping of the mutually complementary devices).

These devices each have an opening, (e.g., a hole), wherein these openings and these devices are arranged and formed on the respective individual tooth in such a way that, in the case in which the at least two individual teeth are arranged on one another and connected to one another, the openings form a common continuous channel in which a retaining device or component for supporting or possibly exclusively producing the positive connection of these individual teeth may be positioned.

These openings and these devices may be arranged and formed on the respective individual tooth in such a way that the channel extends in an axial direction.

A stator for the electric machine has a stator tooth arrangement of this kind, wherein a winding for carrying an electric current is placed on each individual tooth. The electric machine, for its part, includes this stator and a rotor. The rotor is configured as an internal rotor and is arranged radially within the stator.

The concept underlying the disclosure includes connecting the stator teeth to one another in positive inter-engagement to form a complete stator ring in order, ultimately, to prevent the possibility of a change in the position of an individual stator tooth during the shrink fitting process. Manufacture in a manner close to the design, operation of the electric motor with maximum efficiency, and reduction of the production costs by eliminating finish grinding work are the result.

### BRIEF DESCRIPTION OF THE DRAWINGS

Further advantages and embodiments may be found in the drawings and the corresponding description.

In the text which follows, the disclosure and exemplary embodiments are explained in more detail with reference to drawings. There, the same components are identified by the same reference signs in various figures. It is therefore possible that, when a second figure is being described, no detailed explanation will be given of a specific reference sign that has already been explained in relation to another, first figure. In such a case, it may be assumed for the embodiment of the second figure that, even without detailed explanation in relation to the second figure, the component identified there by this reference sign has the same properties and functionalities as explained in relation to the first figure. Furthermore, for the sake of clarity, in some cases not all the reference signs are shown in all of the figures, but only those to which reference is made in the description of the respective figure.

FIG. 1 depicts a known electric machine.

FIG. 2 depicts a stator tooth in a first embodiment.

FIG. 3 depicts a stator tooth arrangement according to the first embodiment.

FIG. 4 depicts a stator tooth in a second embodiment.

FIG. 5 depicts a stator tooth arrangement according to the second embodiment.

FIG. 6 depicts a stator tooth in a third embodiment.

FIG. 7 depicts a stator tooth arrangement according to the third embodiment.

FIG. 8 depicts a layer of the stator tooth in the third embodiment.

FIG. 9 depicts another layer of the stator tooth in the third embodiment.

FIG. 10 depicts a first variant of the stator tooth of the second embodiment.

FIG. 11 depicts a second variant of the stator tooth of the second embodiment.

FIG. 12 depicts a stator tooth arrangement according to the variants of the third embodiment.

### DETAILED DESCRIPTION

It should be noted that terms such as “axial”, “radial”, “tangential”, etc. relate to the axis used in the respective figure or in the example described in each case. In other words, the directions axially, radially, and tangentially relate to an axis of rotation of the rotor and hence to the corresponding axis of symmetry of the stator. “Axial” herein describes a direction parallel to the axis. “Radial” describes a direction orthogonal to the axis, toward or away from the latter. “Tangential” is a direction orthogonal to the axis and orthogonal to the radial direction, which is directed in a circle around the axis at a constant radial spacing from the axis and with a constant axial position. The expression “in the circumferential direction” is equivalent to “tangential”.

In relation to an area, (e.g., a cross-sectional area), the terms “axial”, “radial”, “tangential”, etc. describe the orientation of the normal vector of the area, e.g., of the vector which is perpendicular to the area concerned.

In connection with components, (e.g., coils or stator teeth), the term “adjacent” is intended to express the fact that, in the case of “adjacent components”, there is, in particular, no further such component between these two components but at most an empty intermediate space.

Here, the expression “coaxial components”, (e.g., coaxial components such as the rotor and the stator), is taken to include components which have identical normal vectors, for which, therefore, the planes defined by the coaxial components are parallel to one another. Furthermore, the expression is intended to entail that the centers of coaxial components lie on the same axis of rotation or symmetry. However, these centers may lie in different axial positions on this axis, and therefore the planes may be at a mutual spacing greater than 0. The expression does not necessarily require that coaxial components have the same radius.

The term “accurately fitting” is intended to express the fact that a component placed in an “accurately fitting” manner in or on another component is placed without play or freedom of movement.

In connection with two components which are “complementary” to one another, the term “complementary” means that their external shapes are configured in such a way that one may be arranged, (e.g., completely), in the component complementary to it, with the result that the inner surface of one component and the outer surface of the other component may be in contact without gaps or over their full area. Consistent with this, therefore, in the case of two mutually complementary objects the outer shape of one object is defined by the outer shape of the other object. The term “complementary” may be replaced by the term “inverse”.

For the sake of clarity, it may be the case that, in some of the figures, in cases in which components are present in multiple instances, not all the components illustrated are provided with reference signs. This applies to reference signs 112, 121 and 122, for example.

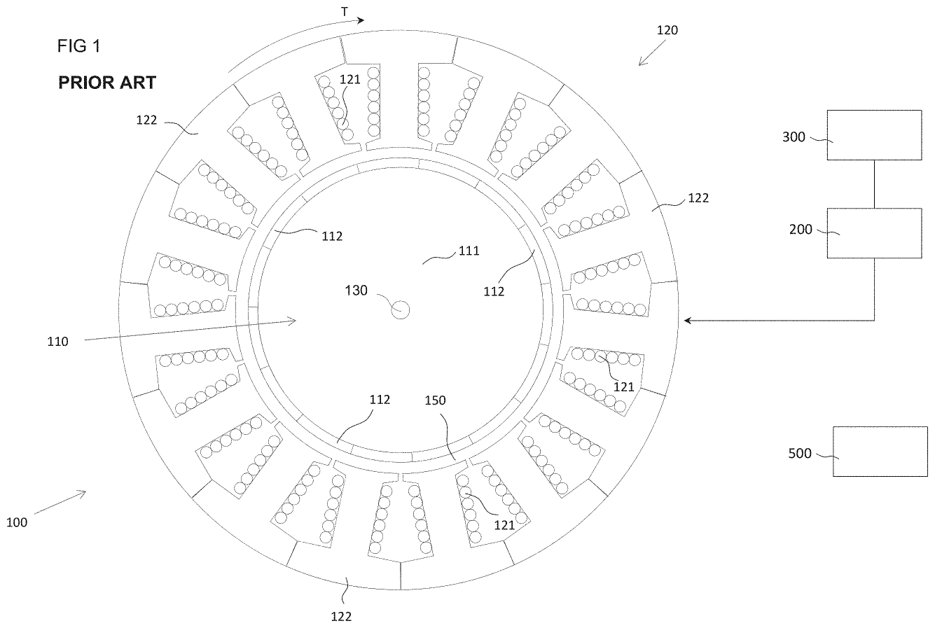

FIG. 1 shows in greatly simplified form a system 1 or drive system of an electric airplane having an electric machine 100 of the kind known in the prior art designed, by way of example, as an electric motor. The electric machine 100, in a similar construction, may also be operated as a generator. It may furthermore be emphasized that the construction of the machine 100 described below is greatly simplified and serves merely to illustrate the basic operation of the electric motor or electric machine. It may be assumed to be known that the various components of the machine 100 may be arranged differently, depending on the specific desired design of the electric machine 100 as a generator or as an electric motor and/or as, for example, a radial-flow or axial-flow machine with a rotor designed as an internal or external rotor, etc. In the example discussed here, however, it is the machine with a rotor configured as an internal rotor which is of interest.

The electric motor 100 has an annular or hollow-cylindrical stator tooth arrangement 120 and a cylindrical rotor 110, formed here as an internal rotor, the rotor 110 being arranged within the stator tooth arrangement 120 and concentrically therewith and, in the operating state of the electric motor 100, rotating about an axis of rotation. The rotor 110, or its cylindrical rotor main body 111, respectively, is connected to a shaft 130 for conjoint rotation therewith, so that a rotation of the rotor 110 may be transmitted via the shaft 130 to a component to be driven (not shown), for example to a propeller of an airplane.

The stator tooth arrangement 120, which forms the majority of the stator of the electric machine, has a multiplicity of individual stator teeth 122 as well as a first magnetic means 121, which may be implemented as windings 121 of a stator winding system, for example. Each of the windings 121 has been wound onto one of the stator teeth 122 of the stator tooth arrangement 120 and, in the operating state of the electric motor 100, is flowed through by an electric current, so that magnetic fields are generated. The rotor 110 has second magnetic device 112, which are designed as permanent magnets 112, for example, and may be arranged on a surface of the rotor main body 111 facing the stator tooth arrangement 120.

The first and the second magnetic devices or components 121, 112 are configured and spaced apart from one another by an air gap 150 in such a manner that the first and second magnetic devices 121, 112 interact electromagnetically with one another in the operating state of the electric motor 100. This concept, including the conditions for the formation and precise arrangement of the magnetic devices 112, 121 or of the rotor 110 and stator tooth arrangement 120, are known per se and are therefore not explained in more detail in the text which follows. In order to operate the electric machine 100 as an electric motor, the stator winding system or the windings 121 thereof are supplied with electric currents with the aid of a merely indicated power source 200, 300. The electric currents cause the windings 121 to generate corresponding magnetic fields which come to interact electromagnetically with the magnetic fields of the permanent magnets 112 of the rotor 110. This results in a torque acting in a tangential direction or circumferential direction on the permanent magnets 112, which, provided that the permanent magnets 112 are connected sufficiently firmly to the rotor main body 111, results in the rotor 110 and conjointly therewith the shaft 130 being set in rotation when said components are suitably configured and disposed in relation to one another.

The power source 200, 300 includes an electric energy source 300, (e.g., a battery or an electric generator), and power electronics 200, which convert the electric energy made available by the energy source 300 into the current/voltage signal instantaneously required by the electric motor 100 to produce the power demanded, for example, by an operator of the system 1. The system 1 is subject to open-loop and/or closed-loop control by a control system 500 in accordance with inputs by an operator of the system 1. Depending on the use of the system 1, the operator of the system 1 may be, for example, a pilot or a driver or the user of an industrial plant that employs a drive system of this kind. Depending on the degree of automation, however, the operator may also be a higher-level monitoring, open-loop control, and/or closed-loop control system of the system, e.g., if the system 1 does not form a drive system but, for instance, an industrial plant having an electric machine 100 of this kind.

This concept of forming the electric machine 100 as an electric motor may be known. The alternative configuration and use of the electric machine 100 as a generator may also be known. In the latter operating mode, the component 300 in FIG. 1 may be understood as a load, e.g., once again, as a rechargeable battery and/or as an electric motor. A current/voltage signal supplied by the generator 100 is converted by the power electronics 200 into a current/voltage signal that may be processed by the load. On account of the familiarity of the concepts, the two forms of the electric machine 100 are not detailed any further in the text which follows.

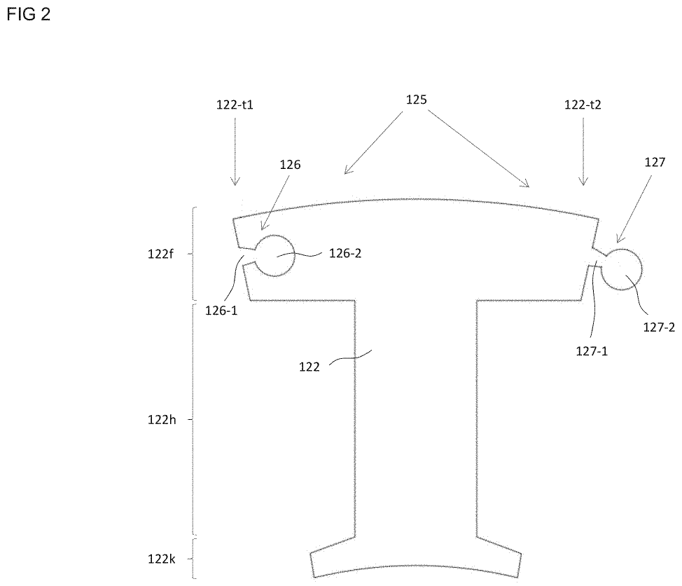

In this and also in the other embodiments, each individual tooth 122 has a tooth head 122k which faces the rotor 110 of the machine 100 in the assembled state of the machine 100, a tooth root 122f facing away from the rotor 110, and a tooth neck 122h arranged between the tooth head 122k and the tooth root 122f. This may be seen, for example, in the illustration in FIG. 2. Both in the positive and in the negative tangential direction T, the tooth head 122k and the tooth root 122f extend beyond the tooth neck 122h.

The respective stator winding may be situated on the tooth neck 122h, but this is not illustrated in the following figures for the sake of clarity. Ultimately, the totality of the tooth roots 122f forms a ring, which may assume the function of the stator yoke.

As already mentioned in the introduction, the individual teeth 122 may be welded to one another in the region of the tooth roots 122f, e.g., at the radially outer contact points between two adjacent individual teeth 122. However, this is not illustrated in FIG. 1. In contrast, the stator teeth 122 in the embodiments described here have connecting devices 125, with the aid of which two adjacent individual teeth 122 may be connected positively to one another.

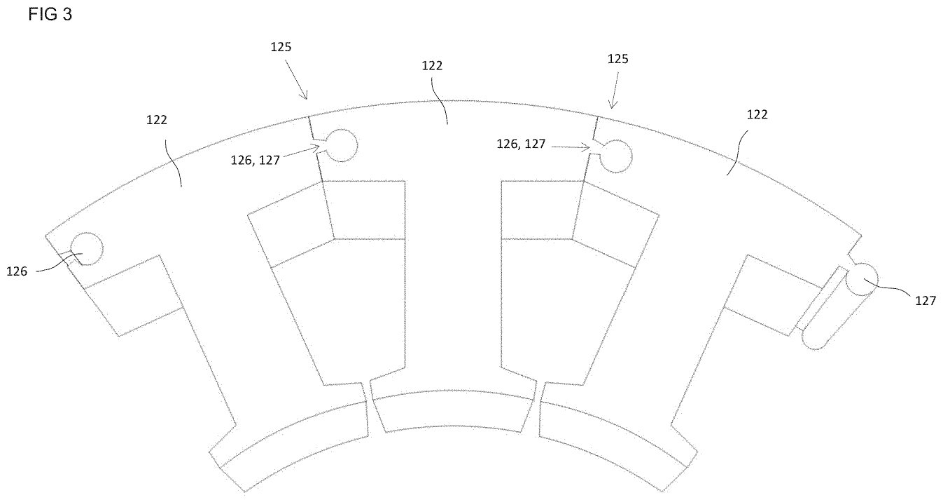

In the first embodiment, which is illustrated in FIGS. 2 and 3, the connecting device 125 is designed in the manner of a tongue and groove joint. Accordingly, each individual tooth 122 has a groove-type depression 126 and a projection 127 complementary to the depression 126. The depression 126 is arranged on one side 12241 of the two sides 122-t1, 122-t2 of the tooth root 122f, which lie opposite one another in the circumferential direction or tangential direction. The depression 126 extends into the tooth root 122f in the tangential direction. The projection 127 is arranged on the corresponding other tangential side 122-t2 of the same tooth 122 and extends away from the tooth root 122f in the tangential direction. Both the depression 126 and the projection 127 extend in the axial direction along the respective side 122-t21, 122-t2 in the tooth root region 122f of the respective individual tooth 122.

Owing to the mutually complementary designs of the depression 126 and the projection 127, the projection 127 of a first individual tooth 122 may be positioned in an accurately fitting manner and so as to form a positive connection within the depression 126 of a second individual tooth 122 to be arranged adjacent to the first tooth 122, e.g., by pushing the projection 127 of the first tooth 122 into the depression 126 of the second tooth 122 in the axial direction.

The connecting device 125 and, in this context, more particularly the depressions 126 and the projections 127 are designed in such a way that the respective positive engagement has no effect only in the axial direction, while the adjacent individual teeth 122 connected by the connecting device 125 have no mutual freedom of movement in the radial and tangential directions.

In the first embodiment, the projection 127 is designed as a round head and, accordingly, has a region 127-2 of a round cross section when viewed in the axial direction. This round region 127-2 is connected to the second side 122-t2 by a web-type connection 127-1. As already mentioned, the depression 126 formed on the first side 122-t1 is of complementary design to this round head projection 127 and therefore has a region 126-2, in which the round region 127-2 may be positioned in an accurately fitting manner, and a region 126-1 for the web-type connection 127-1.

FIG. 3 shows, in a perspective view, three adjacent teeth of the multiplicity of individual stator teeth 122 in the first embodiment, wherein, in each case with individual teeth 122 arranged adjacent, the projection 127 of one individual tooth 122 is positioned in the depression 126 of the adjacent individual tooth 122, with the result that these adjacent teeth 122 are connected positively to one another. The other individual teeth of the stator tooth arrangement 120 that form the stator tooth arrangement 120, but are not illustrated here, are designed accordingly and arranged in such a way that, ultimately, the annular stator tooth arrangement 120 is formed.

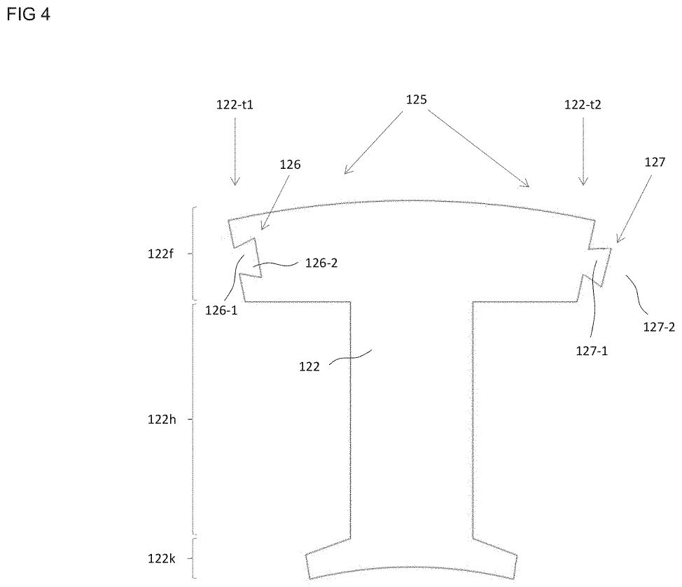

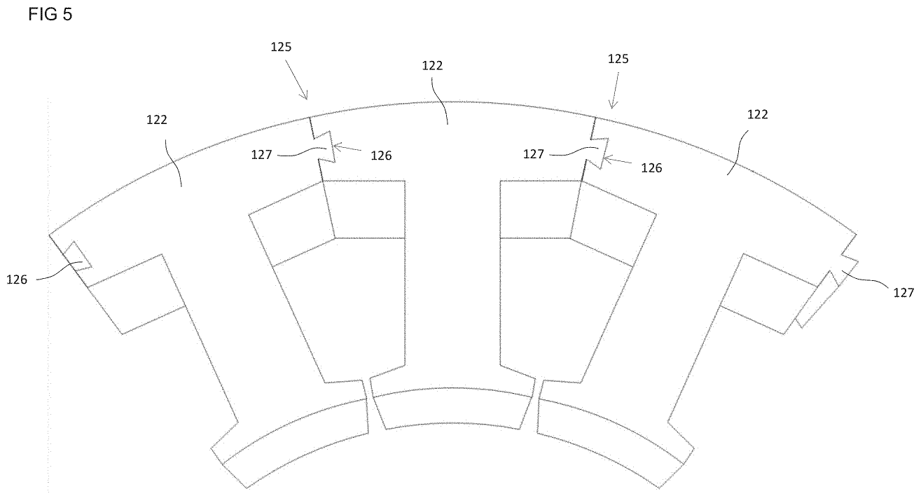

In the second embodiment, which is illustrated in FIGS. 4 and 5, the connecting device 125 is likewise designed in the manner of a tongue and groove joint, wherein, once again, each individual tooth 122 has a projection 127 and a groove-type depression 126 complementary to the projection 127, which, in a manner corresponding to the first embodiment and as described in connection with FIG. 2, are formed on the two sides 122-t1, 122-t2 and which, once again, extend in the axial direction along the respective side 122-t1, 122-t2 of the tooth root 122f. In contrast to the first embodiment, in which the projection 127 is designed as a round head and the depression 126 is designed in a correspondingly complementary manner, the connecting device 125 in the second embodiment is designed as a dovetail joint. Accordingly, the projection 127 has a trapezoidal cross section when viewed in the axial direction, wherein the short side thereof faces the tooth root 122f and the long side faces away from the tooth root 122f.

Owing to the mutually complementary designs of the depression 126 and the projection 127, it is also possible in the second embodiment for the projection 127 of a first individual tooth 122 to be positioned in an accurately fitting manner and so as to form a positive connection within the depression 126 of a second individual tooth 122 to be arranged adjacent to the first tooth 122. This is once again demonstrated in FIG. 5 by three individual teeth 122 arranged adjacent to one another.

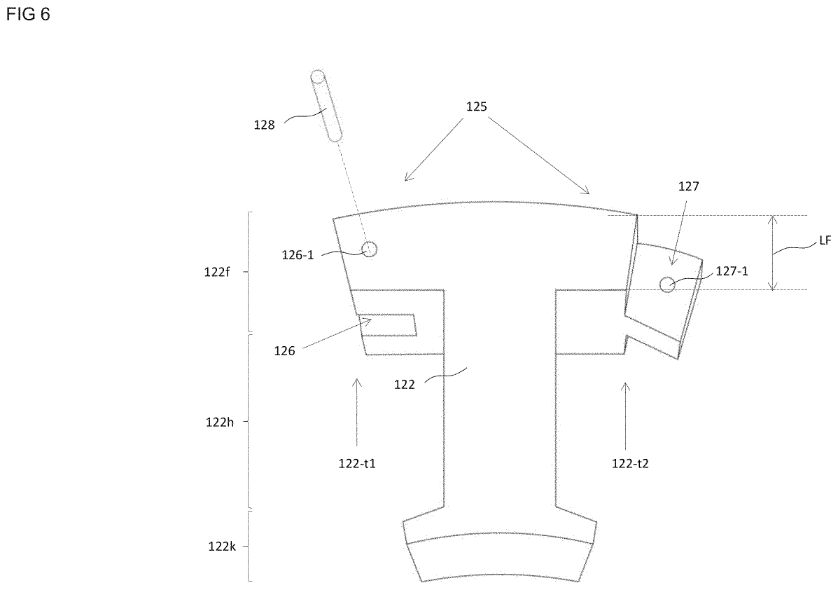

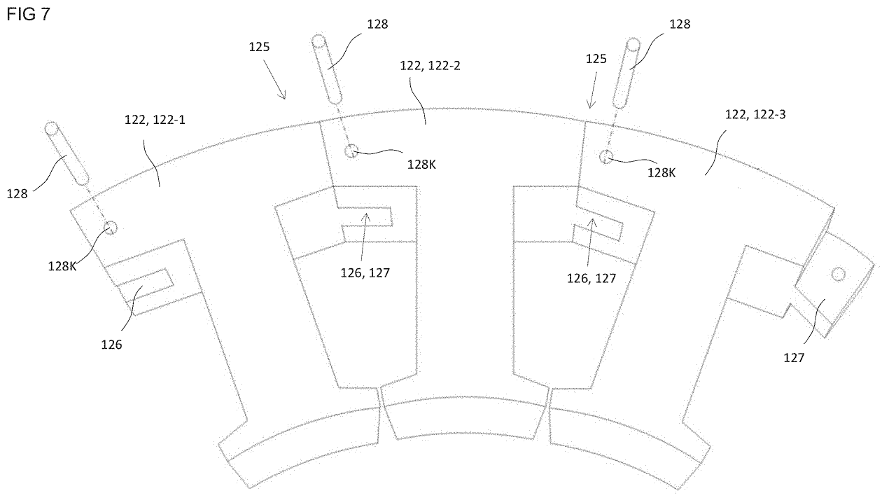

In the third embodiment too, which is illustrated in FIGS. 6 and 7, it is ultimately provided, with the aid of the connecting device 125, that individual teeth 122 arranged adjacent to one another may be connected positively to one another. In order to be able to clarify the specific design of the connecting device 125 in the third embodiment, the individual tooth 122 in FIG. 6 is illustrated in perspective.

Once again, each individual tooth 122 has a depression 126 on one side 12241 of the two tangential sides 122-t1, 122-t2 of the tooth root 122f, and, on the other side 122-t2, has a projection 127.

Once again, the projection 127 is of complementary design to the depression 126, thus enabling the projection 127 of one stator tooth 122 to be positioned in an accurately fitting manner in the depression 126 of an adjacent, further individual tooth 122. In contrast to the first and to the second embodiment, however, the depression 126 and the projection 127 of the third embodiment are not shaped in such a way that the respective connecting device 125 achieves mutual fixing of adjacent individual teeth 122 connected by the connecting device 125 exclusively through the design of the depression 126 and the projection 127, e.g., without an additional device or component. In the third embodiment, this fixing is achieved in a different way, namely by an additional retaining device or component 128 of the connecting device 125, (e.g., a pin), which may be pushed through correspondingly designed and arranged openings or holes 126L, 127L on or in the depression 126 and on or in the projection 127, and may be fixed there. This depression 126, the projection 127, and the holes 126L, 127L provided there are arranged and formed on the respective individual tooth 122 in such a way that, in the case in which the individual teeth 122 are arranged adjacent to one another and connected to one another, the holes 126L, 127L form a common continuous channel 128K, in which the respective pin 128 for supporting or establishing the positive connection of these individual teeth 122 may be positioned.

If, therefore, two individual teeth 122 are positioned in such a way adjacent to one another that the projection 127 of one of the individual teeth 122 rests in an accurately fitting manner in the corresponding depression 127 of the adjacent individual tooth and, furthermore, the pin 128 is placed in the holes 126L, 127L, these two individual teeth 122 are fixed on one another.

Owing to the mutually complementary designs of the depression 126 and the projection 127, it is also possible in the third embodiment for the projection 127 of a first individual tooth 122 to be positioned in an accurately fitting manner within the depression 126 of a second individual tooth 122 to be arranged adjacent to the first tooth 122. With the aid of the respective pin 128, a positive connection of the individual teeth 122 arranged in such a way relative to one another is once again ultimately formed. This is demonstrated once again in FIG. 7 by three individual teeth 122 or 122-1, 122-2, 122-3 arranged adjacent to one another, wherein the illustration shows a situation in which the pins 128 have not yet been positioned in the holes. The dashed lines merely indicate the positioning.

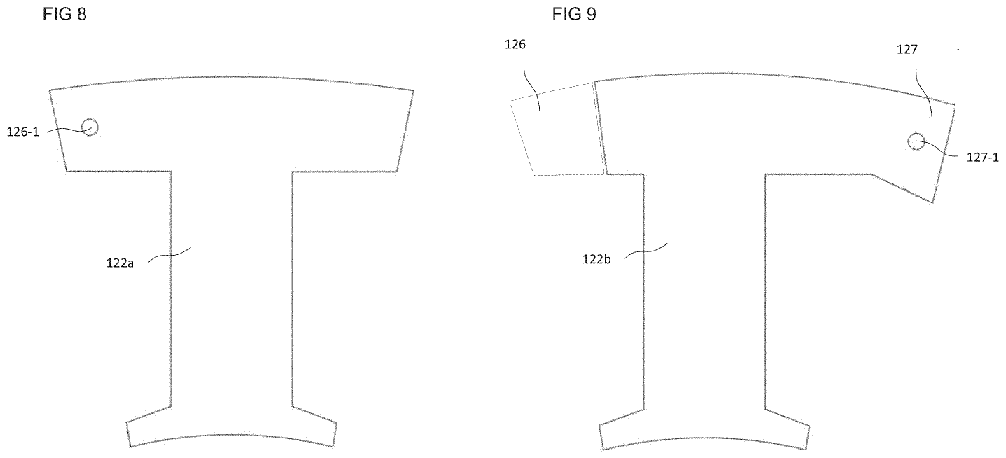

In the third embodiment, which is illustrated in FIGS. 6 and 7 and which, in particular, differs from the first and the second embodiment in having the additional retaining component 128, the projection 127 on the corresponding side 122-t2 at the root 122f of the respective stator tooth 122 extends in the radial direction and over the entire radial extent LF of the tooth root 122f. The depression 126 complementary thereto is designed accordingly and, once again, is provided on the opposite side 122-t1. The implementation of this special shape of the stator tooth 122 is possible in a relatively simple manner owing to the, e.g., sheet-metal construction of the stator tooth arrangement 120 or teeth 122, because all that is required to achieve the desired shape is to produce and suitably stack two sheets 122a, 122b of different design or shape. FIGS. 8 and 9 show, by way of example, the two differently shaped sheet-metal types 122a and 122b required for the implementation of the likewise illustrative shape illustrated in FIG. 6, which, when stacked appropriately on one another, form the stator tooth 122. For the sake of clarification, the recessed region, which ultimately corresponds to the depression 126, is also indicated by a dashed line in FIG. 9.

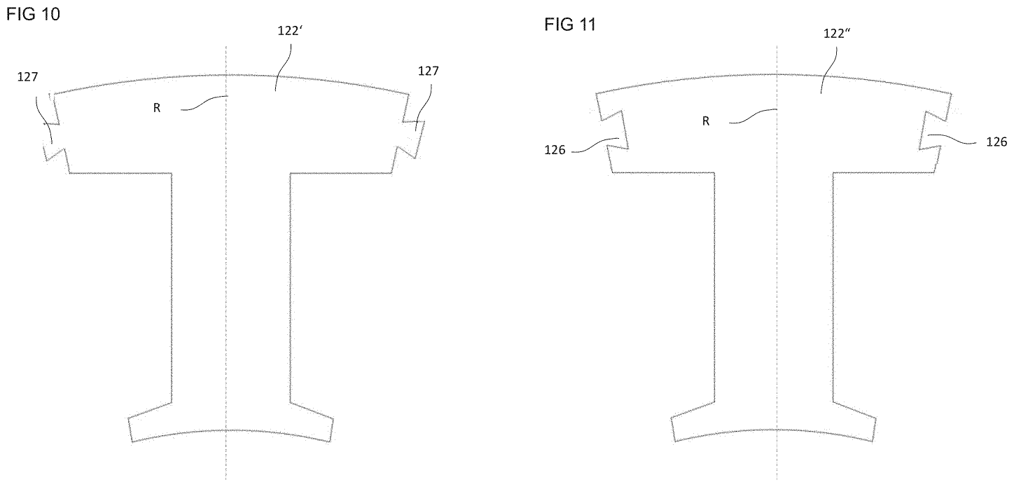

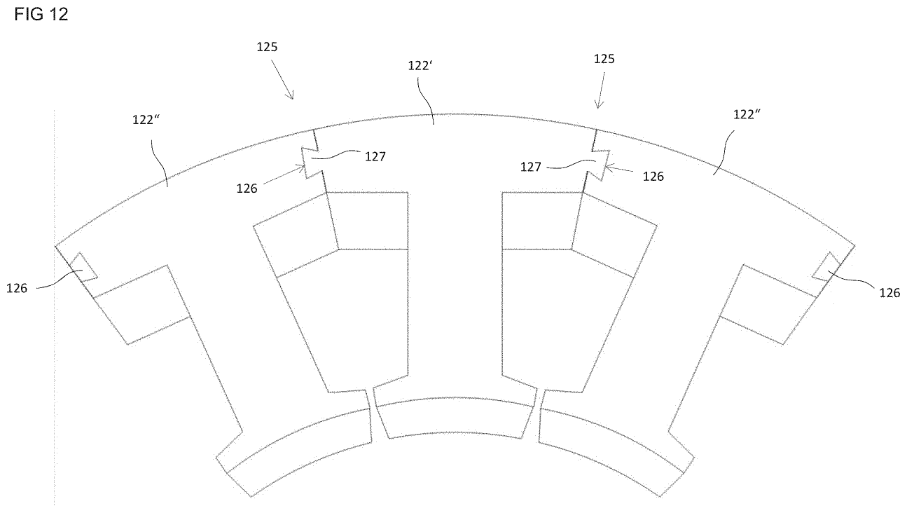

The embodiments explained so far envisage that a projection 127 and a groove-type depression 126 complementary thereto are provided on one and the same individual tooth 122. It is thus possible to construct the stator tooth arrangement 120 with a multiplicity of individual teeth 122 that are identical per se. As an alternative thereto, it is conceivable to assemble the stator tooth arrangement 120 on the basis of two different embodiments 122′, 122″ of individual teeth 120. It is possible, for example, for one of the embodiments of individual teeth 122′ to have projections 127 on both tangential sides 122′-t1, 122′-t2, while the other embodiment of an individual tooth 122″ has groove-type depressions 126 complementary thereto on both of its tangential sides 122″-t1, 122″-t2. These teeth 122′ and 122″, which are substantially mirror-symmetrical in relation to the radial axis R, are illustrated in FIGS. 10 and 11, wherein, by way of example, the projections 127 and depressions 126 are embodied in accordance with the construction of the already explained dovetail joint 125. Of course, the depressions 126 and projections 127 of these individual teeth 122′, 122″ may also be of different design, e.g., as in the other embodiments described above, wherein a common feature of the embodiments is that positive connections are formed in each case.

In this case, as illustrated in FIG. 12, the stator tooth arrangement 120 is assembled in a consistent way by arranging the different individual teeth 122′, 122″ alternately in series and connecting them positively to one another.

Common to the different embodiments explained is that the respectively effected connection between two individual teeth 122 or 122′, 122″ is positive, wherein in each case mutually adjoining sides 12241 or 122′-t1, 122″-t1 and 122-t2 or 122′-t2, 122″-t2 of the adjacent individual teeth may be in full-surface contact and, by virtue of the positive engagement, this full-surface contact is maintained even under the initially described loading during shrink fitting. Other embodiments by which this positive engagement may be achieved are conceivable.

Although the disclosure has been illustrated and described in greater detail by the exemplary embodiments, the disclosure is not restricted by these exemplary embodiments. Other variations may be derived herefrom by the person skilled in the art, without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A stator tooth arrangement for a stator of an electric machine, the stator tooth arrangement comprising:
a multiplicity of individual teeth arranged in series when viewed in a tangential direction; and
a connecting device,
wherein individual teeth of the multiplicity of individual teeth which are arranged adjacent to one another are connected positively to one another at respective tooth roots of the individual teeth by the connecting device.

2. The stator tooth arrangement of claim 1, wherein each tooth of the multiplicity of individual teeth comprises a tooth head facing a rotor of the electric machine, a tooth root facing away from the rotor, and a tooth neck arranged between the tooth head and the tooth root.

3. The stator tooth arrangement of claim 1, wherein the connecting device comprises a multiplicity of mutually complementary devices,
wherein each individual tooth of the multiplicity of individual teeth has a complementary device on each side of two tangential sides of the respective tooth root of the individual tooth,
wherein the individual teeth are arranged in series when viewed in the tangential direction in such a way that the complementary devices on mutually facing tangential sides of two adjacent individual teeth are complementary to one another and bring about a positive connection of the respectively adjacent individual teeth when positioned one inside the other.

4. The stator tooth arrangement of claim 3, wherein a first portion of the multiplicity of mutually complementary devices are groove depressions, and a second portion of the multiplicity of mutually complementary devices are projections complementary to the groove depressions.

5. The stator tooth arrangement of claim 4, wherein the multiplicity of mutually complementary devices on both tangential sides of the tooth root of each individual tooth are of a same type.

6. The stator tooth arrangement of claim 4, wherein the multiplicity of mutually complementary devices arranged on both tangential sides of the tooth root of each individual tooth are complementary to one another.

7. The stator tooth arrangement of claim 3, wherein the multiplicity of mutually complementary devices on both tangential sides of the tooth root of each individual tooth are of a same type.

8. The stator tooth arrangement of claim 3, wherein the multiplicity of mutually complementary devices arranged on both tangential sides of the tooth root of each individual tooth are complementary to one another.

9. The stator tooth arrangement of claim 3, wherein, for at least two adjacent individual teeth of the multiplicity of individual teeth, the complementary devices arranged on the mutually facing tangential sides of the adjacent individual teeth are configured to form a dovetail joint with one another.

10. The stator tooth arrangement of claim 9, wherein the complementary devices on a respective tangential side of a respective tooth root extend in an axial direction.

11. The stator tooth arrangement of claim 3, wherein, for at least two adjacent individual teeth of the multiplicity of individual teeth, the complementary devices arranged on the mutually facing tangential sides of the adjacent individual teeth are configured to form a round head joint with one another.

12. The stator tooth arrangement of claim 11, wherein the complementary devices on a respective tangential side of a respective tooth root extend in an axial direction.

13. The stator tooth arrangement of claim 3, wherein, for at least two adjacent individual teeth of the multiplicity of individual teeth, the complementary devices arranged on the mutually facing tangential sides of the adjacent individual teeth are configured in such a way that a retaining component may be received by the respective complementary devices to support the positive connection of the adjacent individual teeth.

14. The stator tooth arrangement of claim 13, wherein the complementary devices each have an opening,
wherein the openings of the complementary devices and the complementary devices are arranged and formed on the respective individual teeth in such a way that, when the at least two individual teeth are arranged on one another and connected to one another, the openings form a common continuous channel in which the retaining component for supporting the positive connection of these individual teeth is configured to be positioned.

15. The stator tooth arrangement of claim 14, wherein the common continuous channel extends in an axial direction.

16. A stator for an electric machine, the stator comprising:
a stator tooth arrangement having:
a multiplicity of individual teeth arranged in series when viewed in a tangential direction; and
a connecting device,
wherein individual teeth of the multiplicity of individual teeth which are arranged adjacent to one another are connected positively to one another at respective tooth roots of the individual teeth by the connecting device.

17. The stator of claim 16, wherein each tooth of the multiplicity of individual teeth of the stator tooth arrangement comprises a tooth head facing a rotor of the electric machine, a tooth root facing away from the rotor, and a tooth neck arranged between the tooth head and the tooth root.

18. An electric machine comprising:
a stator; and
an internal rotor arranged radially within the stator,
wherein the stator comprises a stator tooth arrangement having:
a multiplicity of individual teeth arranged in series when viewed in a tangential direction, wherein each tooth of the multiplicity of individual teeth comprises a tooth head facing a rotor of the electric machine, a tooth root facing away from the rotor, and a tooth neck arranged between the tooth head and the tooth root; and
a connecting device,
wherein individual teeth of the multiplicity of individual teeth which are arranged adjacent to one another are connected positively to one another at the respective tooth roots of the individual teeth by the connecting device.
